(19) United States
(12) Patent Application Publication
(10) Pub. No.: US 2021/0065310 A1
(43) Pub. Date: Mar. 4, 2021

(54) USER INTERFACES FOR INSTANT PAYROLL WITH BULK APPROVAL

(71) Applicant: InstaStaff Technologies,Inc, Atlanta, GA (US)

(72) Inventors: Cherie Kloss, Atlanta, GA (US); Jeff Richards, Atlanta, GA (US)

(21) Appl. No.: 16/551,564

(22) Filed: Aug. 26, 2019

(51) Int. Cl. G06Q 40/00; G06Q 10/10

(52) U.S. Cl. CPC G06Q 40/125; G06Q 40/123; G06Q 10/1091

(57) ABSTRACT

Examples described herein include systems and methods for providing instant payroll with bulk approval. A worker can submit past payroll information to a server. The server can determine predicted deductions, such as tax withholdings, based on average deduction percentages in the past payroll records. The worker can use a graphical user interface (“GUI”) to submit a timecard, which the server can apply estimated deductions to. The server can also apply buffers that further reduce the percentage of pay, based on worker type. A super administrator can use the GUI on a different device to view multiple approved timecards at once and approve payment of the reduced amounts to a plurality of workers.

### BACKGROUND

People often perform weeks of work before being paid for their time. This is true in corporate settings for both employees and contractors. When a worker finishes their shift, it is often not possible for the corporation to pay them at that time. This is in part because deductions need to be applied to the paycheck. The delay between performing the work and receiving payment is inconvenient for workers, who would rather be paid instantly given the choice.

Lending solutions are not profitable for providing early access to shift work payments. Employers therefore bare the risks associated with early payments. Specifically, employers must ensure that they do not pay the worker an amount that turns out to be greater that a net pay amount that includes deductions. Deductions can include, for example, childcare, insurance, social security, Medicare, state taxes, and federal taxes, among numerous potential other deductions. If the worker is paid too much, then the employer can be left in negative territory when they finally receive the amount that would normally be paid to the worker as part of payroll. For example, if a nurse works at a hospital, when the fees are tabulated to pay to the nurse based on payments from a customer, they can be lower than expected due to deductions for that nurse. As a result, the hospital is then in the awkward position of needing to seek reimbursement from the nurse.

To avoid this problem scenario while still paying a worker at the end of a shift, employers currently can give the worker some very low percentage of wages earned. This can ensure that the employer does not overpay based on actual withholdings needed for that worker. However, this is an imperfect solution because the worker is paid significantly less than they are likely entitled too. Additionally, the employer may have to cut multiple different checks and track the different payments in this scenario. This can be cumbersome when the employer is simply writing multiple paper checks.

Existing technologies do not address this problem. While many electronic payment platforms exist for instantly transferring money, none of them provide any means of accurately reducing the payments based on deductions.

Consequently, a need exists for systems and methods that utilize visual overlays for network insights, giving development teams enough diagnostics information to resolve application problems.

### SUMMARY

Examples described herein include systems and methods for providing instant payroll with bulk approval. The systems and methods can allow for employer funded acceleration of a payroll cycle, providing an interface through which a payroll manager can manage the early payments. In one example, an application can be installed on a user device that allows for receiving instant payments for work performed without waiting on actual payroll deductions. The application can cause the user device to display a graphical user interface (“GUI”) through which a worker can create a timecard. The timecard can be based on a template that is specific to the industry of worker, such as a travel nurse or a trucker. The application can send the timecard to a payroll server.

The payroll server can receive multiple timecards from multiple users, including a first timecard created on a first user device through use of the GUI. The worker can make GUI selections to define an amount of time they worked. This can include specifying start and stop times or the total hours. It can also include attaching a picture or file that represents an actual timecard.

The server can then determine a reduced instant payment amount for the first timecard. The reduced instant payment amount can include a deduction based on a payroll history of the first user. For example, if the average deduction percentage from payroll history of that user is 30%, a 30% deduction can be applied. In addition, a buffer can be applied to further reduce payment beyond the 30%. This can help ensure that the estimate is less likely to result in an overpayment. The buffer can be tied to worker type, such as W2 or 1099 worker. The worker type can also account for roles of the worker, such as construction versus nursing. A 1099 construction worker can have a more restrictive buffer than a W2 nurse, in an example. The server can also deduct a configurable fee that can be withheld or paid to the employer as a benefit to providing the early wage access.

The timecards can be approved by a manager or automatically approved based on meeting criteria excepted for that worker, such as job type, destination, and a threshold hours range.

The server can then send a list of timecards to an administrator device (also called a manager device) for bulk approval by a super administrator. The administrator device can be another user device that runs the application and displays the GUI. The GUI of the administrator device can display the list of timecards and allow the super administrator to simultaneously authorize payment for all of the displayed timecards. The timecards can be unchecked to remove them from the bulk approval. Additionally, filters can be applied, such as facility location, date and worker type, to reduce the list of timecards for bulk approval.

For the approved cards, the server can cause a payment processor to send the reduced instant payment amount to the corresponding workers. This can include sending the reduced payment to the first user device.

The method above can be incorporated as instructions in a non-transitory, computer-readable medium. The instructions can be executed by multiple processors to perform the stages of the method. A system that includes a processor and the non-transitory, computer-readable medium can also implement the method. The system can include multiple user devices and a server, in an example.

Both the foregoing general description and the following detailed description are exemplary and explanatory only and are not restrictive of the examples, as claimed.

### BRIEF DESCRIPTION OF THE DRAWINGS

FIG. 1 is a flowchart for an example method for providing instant payroll with bulk approval.

FIG. 2 is an example sequence diagram with stages providing instant payroll with bulk approval.

FIG. 3A is an example illustration of a GUI on a user device creating a timecard for use in providing instant payroll with bulk approval.

FIG. 3B is an example illustration of a GUI on a user device for selecting timecard deduction methods.

FIG. 4 is an example illustration of a GUI for providing instant payroll with bulk approval.

FIG. 5 is an example illustration of a GUI on an administrator device for providing bulk approval of a plurality of timecards.

FIG. 6 is an example illustration of a GUI for providing instant payroll with bulk approval.

FIG. 7A is an example illustration of a GUI for requesting instant payment.

FIG. 7B is an example illustration of a GUI for requesting instant payment.

FIG. 8 is an illustration of example system components for providing instant payroll with bulk approval.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts. Certain words that are used in this disclosure can have various equivalencies and are not intended to be limiting or exclusionary. Examples described herein include systems and methods for providing instant payments with bulk approvals.

In an example, an application can execute on a user device. The application can include a GUI through which a worker can enter a timecard for which instant payment can be requested. When the server receives the timecard, the server can determine a deduction based on past payroll information received from the application for that user. The server can then add the timecard to a list of timecards that display on a GUI of an administrator device. This GUI can include a screen for bulk approval. The manager can approve multiple timecards at once.

The server can cause the GUI on the user device to display a summary for an instant payment that shows the deductions. The user can confirm, causing the server to make the payment minus deductions.

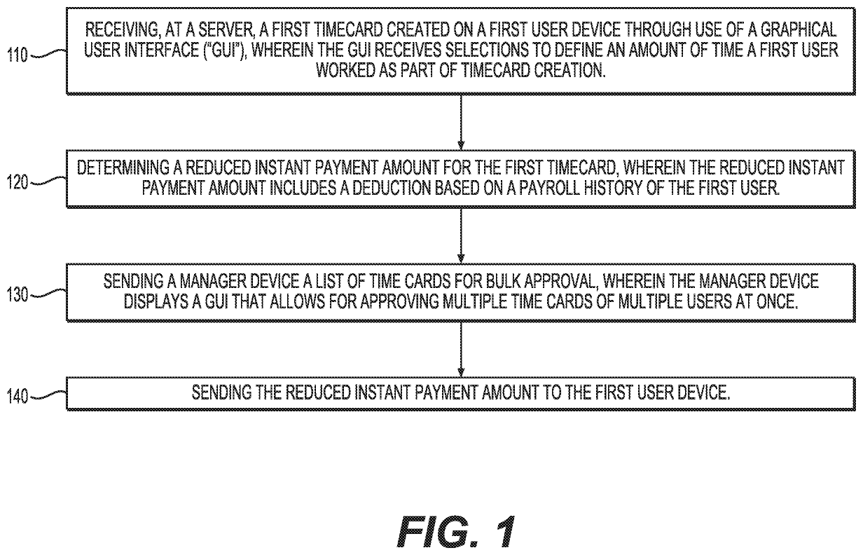

FIG. 1 is an illustration of an example method, with steps for performing instant payment with bulk approval. At stage 110, a payroll server can receive a first timecard from a user device. The timecard can be created at the user device by a worker, referred to here as the first user. To create the timecard, the first user can use a GUI that displays on the user device. The GUI can be part of an application executing at the user device that enables instant payment. The GUI can allow the user to create a timecard, such as by entering hours worked, type of service, or other attributes that can impact wages earned. In one example, the user can import a timecard created in another application. The imported timecard can include a spreadsheet, for example, with hours worked, an hourly rate, a flat fee, or work type that can be used to determine a gross pay amount for the work. In either case, the timecard can indicate an amount of time that the user worked.

The timecard can be received at the payroll server based on the user submitting the timecard via the GUI. The GUI can contact the server and provide credentials that identify the first user. The timecard can indicate the amount of time worked and other information that can allow the server to determine a gross payment amount.

In one example, to submit the timecard, a manager must first approve it. This can be done at the user device, in an example, by allowing the manager to enter a password on the worker's device. The manager can alternatively approve the timecard from a separate device. In one example, the manager can also set up auto-approval status for a user, such that the user's timecard is submitted and automatically approved without manual password entry if the timecard meets certain criteria (e.g., hours or days worked).

At stage 120, the payroll server can determine a reduced instant payment amount based on the timecard. The reduced instant payment amount can be based on a payroll history for the first user. The payroll history can be retrieved, for example, from a database of past payments to the first user. The payroll history can include gross pay amounts and various deductions. The server can average the relative amounts of these deductions to predict how much to deduct from the gross payment amount to arrive at the reduced instant payment amount. For example, the server can calculate the average percentage of taxes deducted from each paycheck as an estimated tax withholding. Another deduction can be a buffer set by an administrator to further ensure no overpayment occurs. The buffer can reduce payment amount by a percentage or set a maximum percentage to pay or minimum percentage to deduct.

The first (i.e., tax) deduction can be determined by a wage estimator engine that executes on the server. The wage estimator can account for whether the first user treated as a 1099 worker or a W2 worker. An administrative user can set payment buffers using a GUI. The payment buffers can include different minimum withholdings that should be used, which can limit the amount paid to the first user beyond the amounts determined based on past payroll history. For example, an administrative user can use the GUI to set the reduced instant payment to be, at most, 80% of the gross pay amount. In one example, the GUI populates with suggested deduction percentages based on the payroll history averages. For example, the GUI can indicate that the first user's deductions are normally 33%. However, the administrative user can then change that payment buffer to require a minimum 40% deduction or maximum 60% payment.

In this way, the past payroll history can be used to determine the deduction, which can then be compared against the minimum withholding to ensure enough is being withheld. The admin can also configure buffers based on a percentage of the values determined from payroll history. For example, the GUI can allow the administrative user to set payment to only 90% of the amount calculated based on payroll history deductions.

Taxes can be estimated as part of determining the deductions. The taxes can be estimated differently based on whether the first user is a W2 worker or 1099 worker. Additionally, deductions related to affiliate splits can be determined. The affiliate splits can differ based on which entities are being paid a split portion of the gross payment amount. Example entities that can contribute to the split portion can include the employer itself, a payment processor, and the application provider.

In one example, an administrative user can use a GUI, such as through a console to the server, to set up criteria for auto approval of timecards. For example, if the worker has a default pay rate set up, a timecard can be auto approved. If there is a facility default rate for the first user, then that rate can be applied. If no facility rate is found, then the server can apply the default pay rate for the first user.

At stage 130, the server can send a list of timecards to an administrator device for bulk payment approval. The list of timecards can display in a GUI at the manager device that is viewed by an administrator or manager of the user. The manager's identity can be pre-associated with the first user. For example, a single super administrator user can be responsible for payment approval for multiple users. The timecards of those users can display on the GUI for that manager.

The GUI can indicate which of the timecards are pre-approved based on meeting the auto approval criteria to allow the super administrator to perform any further inspection. Again, the auto approval criteria can include an hourly rate or default rate. It can also include an allowed range of hours or work type. For example, workers can be preapproved for some hours ranges but not others, in an example. The GUI can highlight timecards that fall outside of these threshold ranges.

These timecards are presented together on the GUI of the manager device. Based on indications of anomalies or pre-approvals, the manager can scan the list and then select a button that approves the timecards in bulk. Rather than approving the timecards one at a time, which can be tedious, this presentation of timecards and the bulk approval option can save the manager time.

The bulk approval is received at the server. Then, at stage 140, the server can send the reduced payment amount to the user device. This can include simply indicating the amount, which displays on a GUI screen at the user device. The GUI can show the reduced instant payment amount, along with various fields indicating multiple predicted deductions. The first user can select an option on the GUI to approve the instant payment. This can cause the server to send payment to the first user, such as by notifying a banking system, printing a physical check, or performing an electronic money transfer between the employer's account and the first user's account.

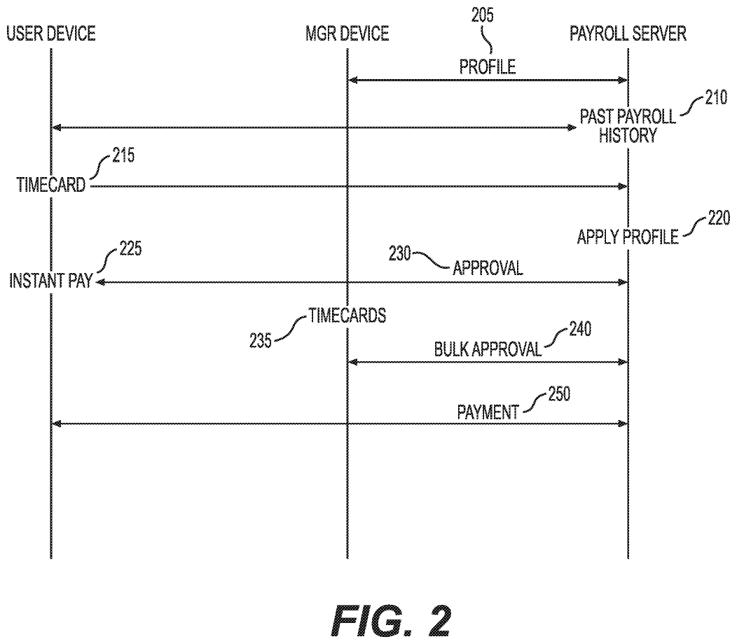

FIG. 2 is an example sequence diagram for instant payments and bulk approvals. At stage 205, an administrative user can set a profile at the payment server for use in determining instant payments and deductions. The administrative user can utilize a manager device that displays a GUI for entering information into the profile. The profile can define payment buffers for different worker types, such as W2 and 1099 workers. These payment buffers can differ between the different work types. A payment buffer can act as a maximum percentage of the gross pay that can be paid instantly. Another payment buffer can indicate a percentage to pay based on the deductions calculated from payroll history. This can allow the system to pay slightly less than determined from payroll history to ensure overpayments do not occur.

The profile can also define affiliate splits that act as deductions to the gross payment amount. The splits can add up to 100%, in an example. For example, the worker can get a large portion, such as 94%, whereas a payment processor gets 1.5%, an affiliate administrator gets 1%, and the application platform gets 3.5%.

The payroll server can use past payroll history to determine predicted deductions for a user at stage 210. These deductions can be calculated for a specific timecard received at stage 215 in an example. The deductions can alternatively be compiled and stored as deduction percentages for the user. A database can store these deduction percentages for multiple users.

At stage 215, the first user can utilize a GUI to create a timecard. The GUI can execute and display on a user device, such as a phone, tablet, or laptop computer. The GUI can be part of an instant payment client application.

In one example, the GUI can allow the user to enter wage information such as the facility where they worked, the work schedule, the hours worked, start and stop times, and work type (e.g., shift type). The GUI can present modifiable screen elements, such as text boxes and drop-down lists, for making these selections. In one example, the GUI can also allow the user to upload a timecard from a different application or a picture of a timecard. This can allow the GUI to automatically populate the wage information, in an example.

In one example, the timecard must be approved by a manager. For example, the user can hand their mobile device to the manager, who can approve the instant payment by entering a manager password into the GUI. This can occur before or after the server receives the timecard, depending on the example. The server can receive the approval and confirm the manager password before storing the timecard as approved. Alternatively, the approval process can include sending the timecard to a user device associated with a manager at stage 235. The timing of this can be part of a bulk approval, as will be covered later, or as one-off event after the user has submitted their timecard at stage 215. The manager can then submit approval using a GUI on their device that is displayed as part of application execution. Alternatively, the manager can access the GUI online and approve the timecard by selecting a link. For example, the server can send the manager an email with a link to click for approval. This can cause the server to be contacted, an in turn, mark the timecard as approved.

In still another example, a manager can set auto-approval criteria that the server can apply to approve user timecards without further manager intervention. The criteria can include minimum or maximum hours, rates, locations, or task types. The manager can use the GUI to enter this auto-approval information.

When the server receives the timecard, the server can apply profiles at stage 220 to determine a reduced instant payment amount. The reduced instant payment amount can be less than the gross pay amount based on deductions. In one example, a first profile is applied that includes deductions calculated based on past payroll history. Those deductions can be percentages of pay that, on average, have been removed from gross pay previously for various deductions. In one example, a second profile can include the buffers set by the administrative user, capping payment to less than the full amount determined from the payroll history. In other words, a buffer profile can be applied to enforce minimum withholdings in addition to a historical profile, which selects withholdings based on past averages. In another example, a single profile can include all of the deductions and buffers.

The profiles can be keyed to user identifiers, such that the server can retrieve profiles relevant to the worker. Additionally, a background process can update profiles based on past payroll history, in an example. In another example, a user can supply past payroll history through the application on the user device, such as by uploading a prior 1099 or W2 form.

The reduced instant payment amount can be sent to the user device for approval at stage 230. This can include sending not only the reduced amount but also the itemized deductions from applying one or more profiles at state 220. The GUI on the user device can display the instant pay summary at stage 225. This GUI screen can allow the user to accept the reduced instant pay amount in view of the deductions. The user device can communicate this acceptance to the server.

In another example, approval at stage 230 can include manager approval similar to that already discussed for stage 235. In an example, the system can wait to solicit manager approval until the user has already agreed to be instantly paid the reduced amount. This can help avoid manager distractions if the user is not otherwise willing to agree to the reduced amount that includes deductions. The manager can access and approve the timecard via email link, in the application GUI, or by being handed the worker's user device for manual passcode entry.

In one example, at stage 240, the server then compiles approved timecards for bulk approval for releasing funds. At this stage, the approved timecards can be accessed in a GUI screen by a super admin, which can be the same manager as in stage 235 or a different administrative user. The super admin can access a GUI screen that displays a list of approved invoices. The GUI screen can highlight discrepancies, such as hours worked, hourly wage, or total payment amount being above maximums. This can allow the super admin to deselect certain timecards for payment. In one example, the user device will notify the user of a rejected timecard. The rejection can include a reason entered by the super administrator, which the user can correct through edits made in the GUI.

Otherwise, the administrative user can select an option to bulk approve the payments. As a result, at stage 250, the server can cause payments to be transmitted to users with approved timecards, including the first user. This can include causing a financial processing system to send electronic funds to an account associated with the first user or the user device. It can also include printing a paper check at an office location for worker pickup.

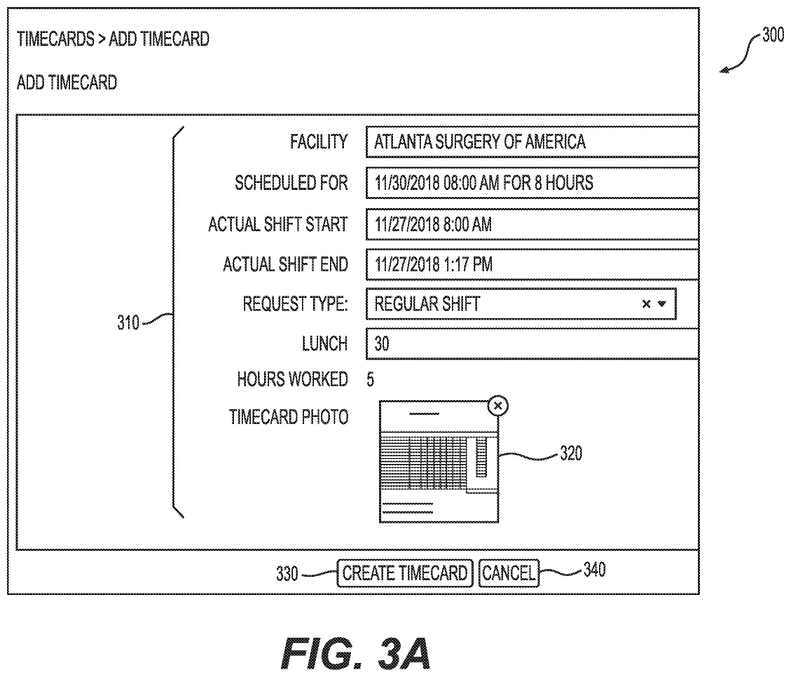

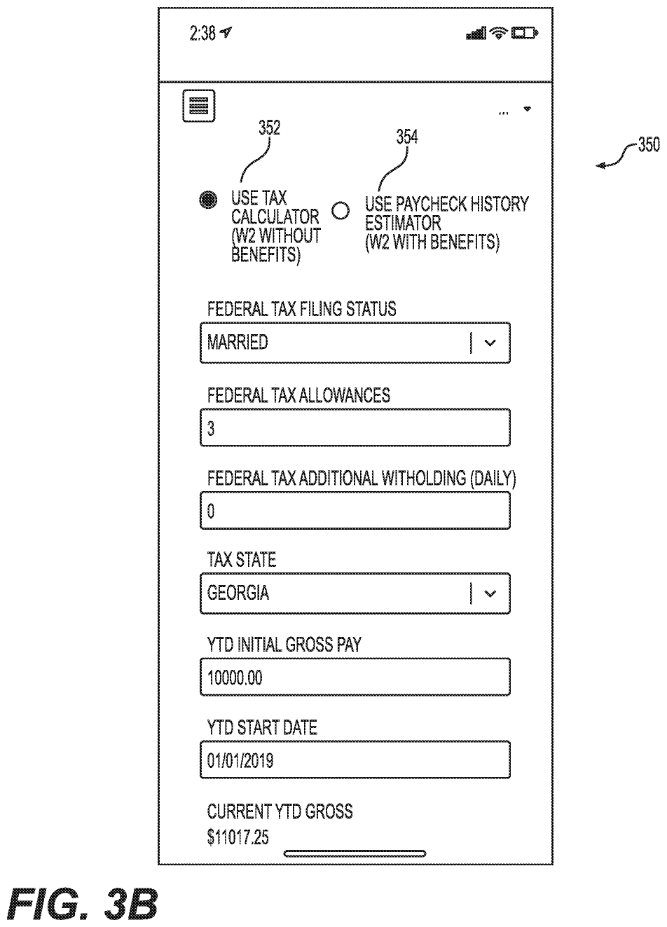

FIG. 3A includes an example GUI screen 300 for creating a timecard. The GUI can be displayed on a user device and communicate with a backend payroll server. The GUI can be part of an application that executes on the user device, in an example. Alternatively, the GUI can be part of a web application that the user accesses over the internet.

In one example, the GUI screen 300 displays in response to the user selecting an option for creating a timecard. In this example, several timecard options 310 are displayed. The user can select the facility where they are working. In this example, the facility is Atlanta Surgery of America. The timecard can include a field for when the work was scheduled, such as the “Scheduled for” field in FIG. 3A. This field can be populated from pre-existing database information at the payroll server or another server, in an example. The “Scheduled for” field can indicate a pre-authorized date and amount of work, in an example.

The options 310 can also include start and end times (e.g., “Actual Shift Start” and “Actual Shift End”), which can allow the user to simply enter when they started and stopped work. The user can also select a work type, such as “Regular Shift.” Different work types can be authorized for different users. In one example, different work types can be associated with different bill rates. For example, a night shift or overtime can be paid differently than a “regular shift.” The user can also specify time deduction, such as by using the “lunch” field. Here, 30 minutes can be entered for lunch. Depending on the user's billing arrangement, this can deduct 30 minutes of time worked. In this example, an “Hours Worked” field can display the remaining total.

The GUI screen 300 can also display an option for uploading a timecard photo 320. The timecard photo 320 can be an attachment that is selected in one example. In another example, the user device can activate a camera mode for taking a picture of a physical timecard. This can allow a manager to review other details that may be included in the actual timecard that are not one of the options 310 provided by the GUI screen.

The GUI screen 300 can also include a button 340 to cancel and another button 330 to create the timecard. Selecting the button 330 to create the timecard can cause the timecard to transmit to the payroll server in an example. This can include merely transmitting the entries from the options 310 and a timecard photo 320, if one exists.

In one example, selecting the button 330 to create a timecard causes the GUI to display a password input window. This can allow for a manager to input a password as part of the timecard creation process, in an example. For example, the user can hand their phone or tablet to the manager who then reviews screen 300. Satisfied that information is correct, the manager can then hit the button 330 to create a timecard. Then the manager can enter their password. The password can be sent with the timecard to the server, where the password can be verified prior to saving the timecard for bulk approval.

FIG. 3B is an illustration of an example GUI screen 350 for selecting how tax withholdings are determined. In one example, the screen 350 is available to users who submit their timecards for instant approval. Alternatively, the screen 350 can be withheld for only those users, managers, or super administrators with a threshold privilege level.

The selection screen 350 can include multiple options 352, 354 to determine how to estimate tax withholdings. The first option 352 can cause the backend server to use a tax calculator, which can estimate tax withholdings without paycheck history. With this option 352, the screen 350 can present various fields for determining the withholding. As shown in FIG. 3B, these fields can include filing status, such as married, single, married-filing-jointly, or married-filing-separately. The user can enter a number of federal tax allowances, additional daily withholdings, and a tax state. This can allow the server to determine estimated federal and state withholdings without a paycheck history.

Alternatively, the user, manager, or super-administrator can select an option for 354 using a paycheck estimator. The application can then send a request to the server, which can analyze a series of paychecks attributed to the user. The server can determine withholdings, for example, by averaging withholding percentages for past paychecks. In one example, the screen 350 can update to include fields for the user to submit past paycheck details, such as gross pay and net pay. A button can allow for submitting the information. The server can use the submitted paychecks to determine an average deduction percentage, which can also display on the screen 350.

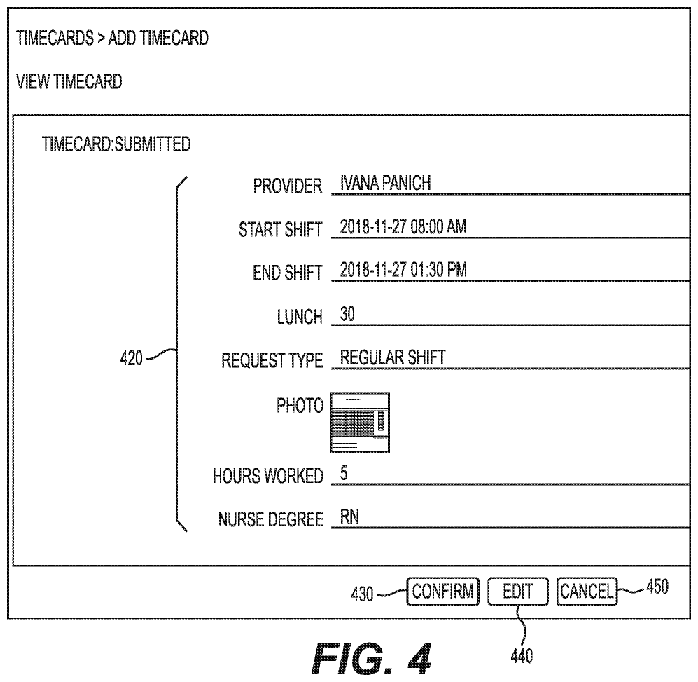

FIG. 4 is an illustration of an example GUI screen for approving a timecard. In one example, the manager can approve the timecard using a GUI on a manager device, such as the manager's phone, tablet, or laptop. Alternatively, the screen of FIG. 4 can be displayed on the user's (i.e., worker's) user device for manager usage. The user can hand their device to the manager, as mentioned above. The manager can review the timecard information 420, including maximizing the timecard photo 320, in an example. Then the manager can either cancel, edit, or confirm the timecard by selecting between buttons 450, 440, 430, respectively.

If the manager selects to edit the timecard, then options 420 can be changed by the manager. In one example, the user is notified through the application that the manager has changed the timecard. The GUI on the user device can highlight those changes.

Once the manager is satisfied that the timecard is correct, the manager can confirm the timecard using button 430.

The payroll server can then determine the reduced instant payment amount based on deductions that are predicted to apply to the timecard. This can be based on historical payroll information, as has been explained. It can be based on one or more profiles including buffers that specify minimum deductions or maximum pay percentage, in an example. In some examples, the user is given the option to approve the reduced payment amount prior to the approved timecard being submitted for instant payment.

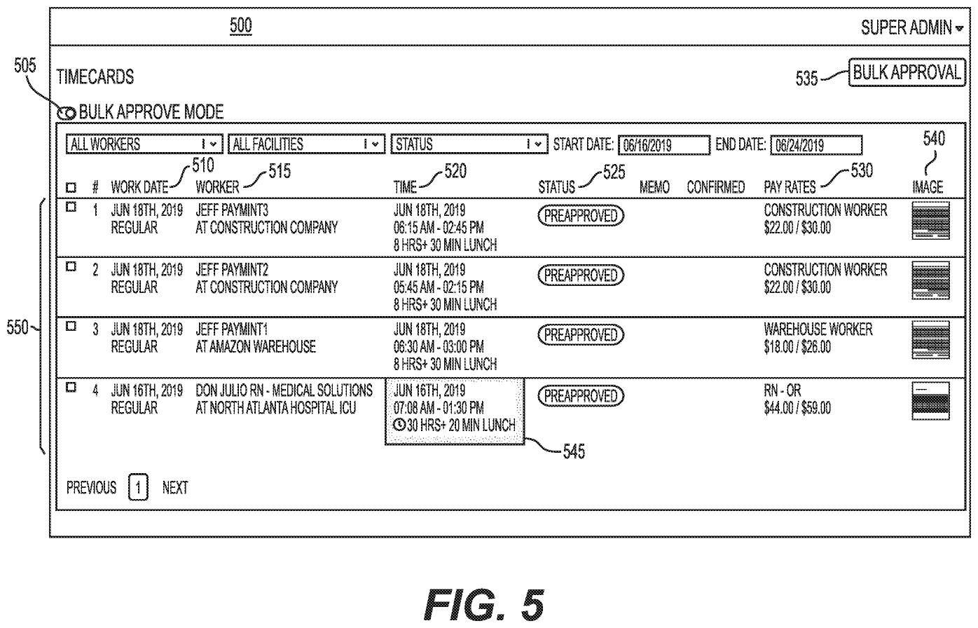

FIG. 5 is an illustration of an example GUI screen 500 for bulk approval for instant payment of numerous timecards. A list 550 of timecards can be presented. The list 550 can include timecards that one or managers have confirmed or auto approved. The GUI screen 500 can be displayed on a console or device accessed by a super administrator, in an example. The console can, for example, provide administrative features related to the payroll server. The super administrator can be an employee or manager tasked with handling payroll decisions for an organization, in an example. The GUI screen 500 can allow the super administrator to authorize payment of the approved timecards, either individually or in bulk.

In this example, a bulk approval mode is turned on with slider 505. This can allow the super administrator to approve numerous timecards for payment by hitting a single button 535, in an example. In this example, four timecards 550 are displayed. However, any number is possible. The displayed timecards 550 can be filtered based on certain groups or types of workers, certain facilities, approval status, and a date range to which the timecard applies, in an example. Filtering based on type of worker can allow, for example, isolating contractor timecards versus employee timecards. This can allow the super administrator to prioritize instant payment of certain worker types. Similarly, choosing a facility can allow the super administrator to isolate and potentially prioritize timecards for workers at the selected facility. This can allow for focused instant payment at facilities where hired help is particularly crucial at a present moment.

The filters, therefore, can dictate which timecards 550 are displayed for bulk approval. Each timecard 550 can be represented as a row in the GUI screen 500. The columns can allow the super administrator to quickly see summary information about the timecards 550. For example, a work date column 510 can present the date that the work occurred and to which the timecard 550 pertains.

A worker column 515 can identify the user (i.e., worker) that has submitted the timecard 550. In one example, the worker column 515 can identify a username entered by the worker, in an example. This can allow for some level of anonymity at the super administrator level, in an example.

A time column 520 can identify the hours worked, including a start time and an end time. The hours worked can highlight differently depending on whether they fall into a normal hours range. If the hours worked fall outside of a threshold range, the GUI screen 500 can highlight the corresponding entry 545 for closer scrutiny by the super administrator. In this example, the fourth timecard in the list 550 includes 30 hours for only one day of work at entry 545. This entry 545 can be highlighted for either editing or deselection by the super administrator prior to allowing a bulk approval of payment for that timecard.

A pay rates column 530 can specify the hourly pay rate for the user. It can also display the worker type, in an example. In this example, the worker type includes construction worker, warehouse worker, and registered nurse.

An image column 540 can include selectable images for each timecard in the list 550. This can allow the super administrator to view the full timecard if a question arises. For example, based on the highlighted element 545, the super administrator can select the corresponding image to see the full timecard. This could explain why the timecard otherwise appears to list 30 hours of work for only one day.

After examining the entries and filtering them as desired, the super administrator can initiate payment for the list 550 by selecting the bulk approval button 535.

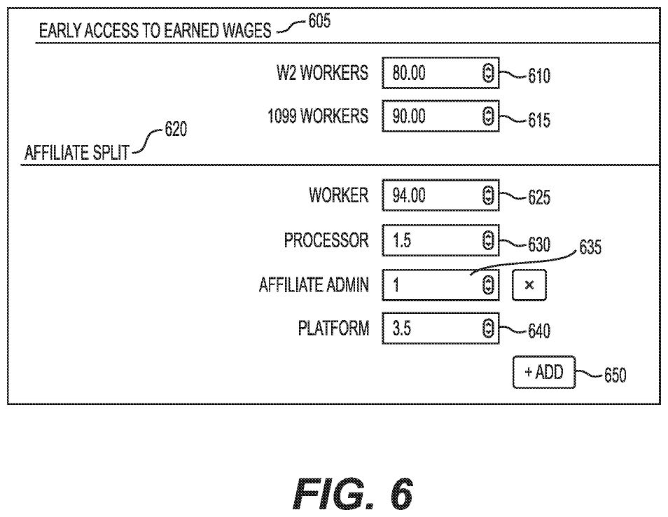

FIG. 6 is an example illustration of a GUI screen for defining buffers, deductions, and splits that can be applied to timecards as part of instant payments. The GUI screen of FIG. 6 can be accessed, for example, by a super administrator who is responsible for an enterprise's payroll.

In the example of FIG. 6, the GUI screen includes a first section 605 for wage access buffers and a second section 620 splits. The buffers can be applied to the predicted tax withholding to further increase the withholding and decrease the reduced payment. Different buffers can be set for W2 workers versus 1099 workers. For example, field 610 sets a W2 worker buffer, which in this example is set to 80%. Field 615 sets a 1099 buffer, which in this example is at 90%. It can be advantageous to set these two worker types differently since the tax laws differ between them.

In the second section 620, splits of the remaining pay after tax withholdings can be set. In this example a worker field 625 can indicate what percentage of the remaining pay will become the reduced instant pay. In this example, it is 94%. This value can update automatically based on other affiliate split values.

A payment processor field 630 can set the deduction percentage from the remaining pay that goes to a payment processor. The payment processor can be a credit card or ACH processor, in an example. The affiliate admin field 635 can be selected to break off a deduction percentage for an affiliate partner, which could be the enterprise (payee) itself. This can help incentivize adoption of the instant payment application. Finally, a platform field 640 can specify the deduction percentage for the payment platform.

These buffers and deductions can be applied when arriving at the reduced instant pay amount.

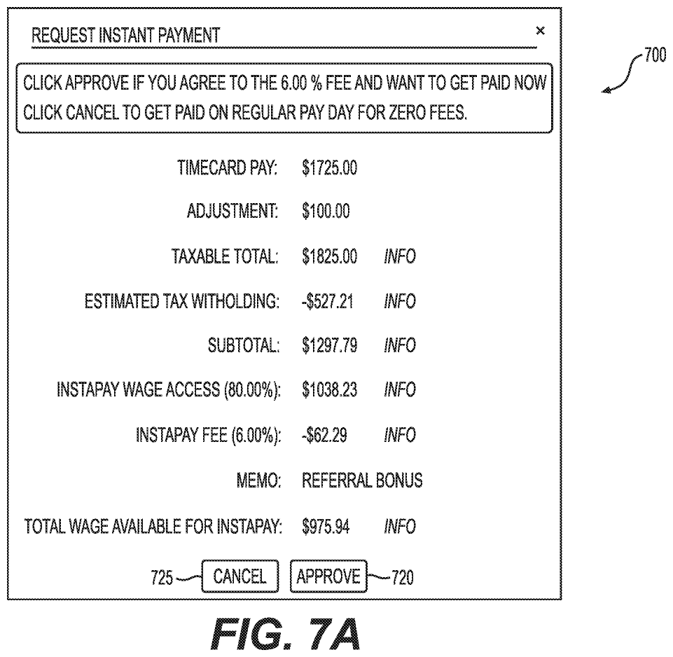

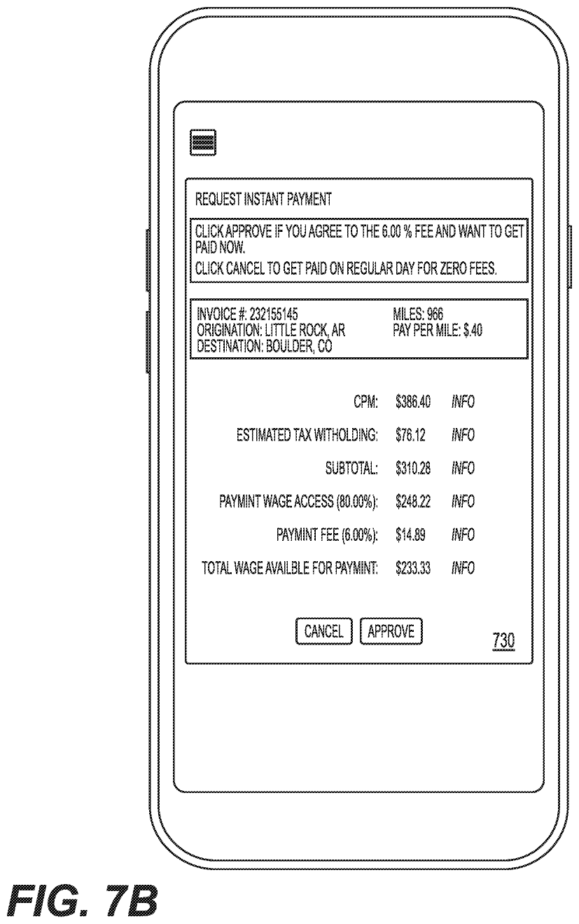

FIG. 7A is an illustration of an example GUI screen 700 shown to a user when confirming they would like instant payment. GUI screen 700 can summarize the payment information for the timecard, including deductions and the reduced instant payment amount. In this example, the gross timecard pay is $1725. However, it also shows an adjustment of $100, which in this case increases the pay. The adjustment could occur based on the manager or super administrator's review of the timecard, in an example. Either could increase the pay for any number of reasons, including believing that the timecard did not reflect all of the worker's time or did not account for some additional special circumstance. In this example the “Memo” field explains the adjustment, citing a “referral bonus.”

The “Taxable Total” shows the total taxable amount, therefore, as $1825. The user can select the respective “Info” link to learn more.

The “Estimated Tax Withholding” field shows the amount that is being withheld for tax purposes. In this example, the amount being withheld is $527.21. This can be determined by the payroll server, such as by a wage estimator engine that executes there. The wage estimator engine can average past payroll withholding percentages for that user, in an example. This average withholding percentage can be stored in connection with the user. This can include storing the withholding percentage in a profile that has a user ID associated with the user. The “Estimated Tax Withholding” can also be determined by applying a buffer to the taxable total. The buffer can be a minimum withholding percentage that is defined for that user.

A “Subtotal” is also presented, subtracting the tax withholding from the taxable total. In this example, the subtotal is $1297.79.

From this subtotal, other deductions can also be displayed. In this example, an “InstaPay Wage Access” of 80% is displayed. The 80% can reflect a maximum pay buffer that is applied to the subtotal. The maximum pay buffer can be part of a profile for that user or for a worker type to which the user belongs. The maximum pay buffer can help ensure that the enterprise does not overpay the worker based on actual withholdings that are greater than the estimated withholdings.

As another deduction, an “InstaPay Fee” of 6% is applied in this example. This deduction can be for operating costs of the payment platform.

Finally, the reduced instant payment amount is shown as “Total Wage Available for InstaPay,” which in this example is $975.94. The user is able to either cancel or approve of this instant payment through use of the corresponding buttons 725, 720. Approving the instant payment can cause the timecard to enter the bulk approval list 550 of FIG. 5, in an example.

FIG. 7B is an example illustration of an alternative timecard template. In one example, the server maintains a user profile that associates the user with an industry or job type. The application GUI can display timecards that use templates specific to an industry of the user. In this example, screen 730 displays a timecard that is tailored to a trucking industry. The invoice includes miles, pay per mile, origin, and destination, rather than hours worked.

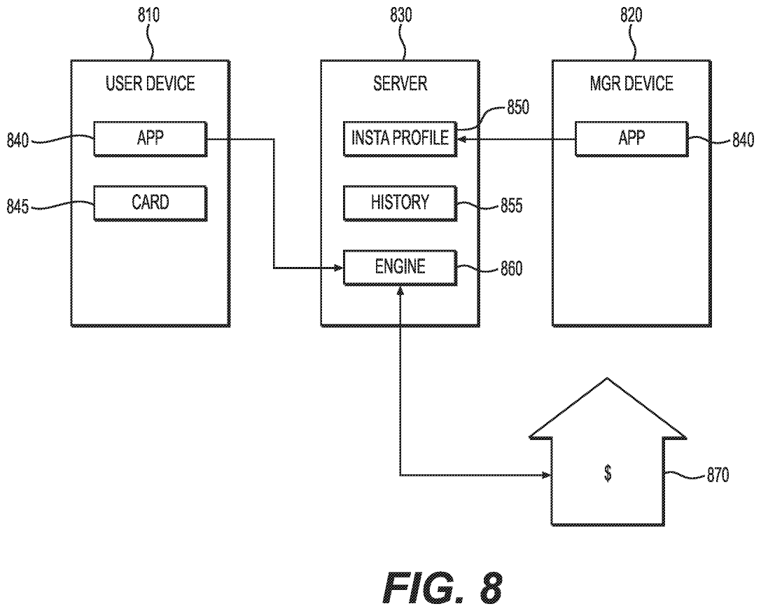

FIG. 8 is an example diagram showing interaction between example system components. Multiple user devices 810 can run an application 840 for instant payments. A user device 810 can be any processor-enabled device, such as a phone, tablet, laptop, or personal computer. The user device 810 can have one or more physical processors that execute instructions from a physical memory, such as a non-transitory, computer-readable medium. These physical memories can be hard drives, solid state drives, or any other type of physical memory.

The application 840 can be downloaded and installed, in an example. Alternatively, it can be accessed over the internet, such as with a web browser. The application 840 can also be a hybrid application that includes a client installed for displaying the GUI, but accesses portions of the GUI or other application components from a remote server. In either case, the application 840 can display a GUI on the user device

Using the GUI, the worker can create a timecard 845. The timecard 845 can be a set of information describing the worker's hours or wage-based task.

The application 840 can transmit the timecard to the server 830 over a network, such as the internet. The server 830 can be one or more servers that each have one or more processors. The server 830 can route timecards (that is, information from a timecard) to other devices as needed, such as to a manager device 820 for approval. The manager device 820 can be another user device in an example. It can be any processor-enabled device, including a tablet, phone, or laptop. In one example, the manager device 840 also runs a version of the application 840, allowing the manager device to display the GUI. The GUI can allow the manager to approve of timecards created by workers that the manager is responsible for.

The server 830 can store multiple profiles 850 for use in determining deductions and a reduced instant payment amount for use in providing instant payments. These profiles 830 can include buffers that specify a maximum payment percentage of a reduced amount from which predicted tax withholdings have already been deducted. The buffers can differ for different worker types, such as W2 workers versus 1099 workers. The buffers can also differ based on job type or based on the payroll history 855 available. In one example, if less than five payroll records are available for a user, a lower maximum payment percentage buffer is used compared to when more than five payroll records are available. This can help ensure that the enterprise does not overpay the worker. It can be difficult to reconcile an overpayment as opposed to an underpayment. When a worker is underpaid using the instant payment application 840, a future payment can be made to the worker to make up the difference. The difference can be based on the actual required withholdings, which may not be known until weeks later.

Payroll history 855 can also be gathered and stored on the server 830. In one example, the user provides past payroll information through the application 840 to the server. This can include taking pictures of past W2 or 1099 forms, or of past pay stubs that include withholdings. Alternatively, physical copies can be provided for manual entry into the system.

The payroll history 855 can be analyzed by a wage estimator engine 860. The wage estimator engine 860 can be a periodic process that runs in one example. This process can loop through workers, averaging the actual the deduction percentages for each of those workers. The average deduction percentages can then be stored as part of profiles 850 for the worker. The profiles can be keyed to user IDs, allowing the server 830 to retrieve different information depending on the user ID sent over by the application 840.

The server 850, such as through using the payroll estimator engine 860, can determine a reduced instant payment amount for quickly paying the worker prior to actual withholdings being known. This reduced instant payment amount can be displayed in the application 840 of the user device 810 so that the worker can approve the payment.

The server can send a list of approved timecards 845 for instant payment to a super administer, who can also access the GUI through a manager device 810. The super administrator can use a different manager device 810 that the worker(s) direct manager in an example. The super administrator can approve multiple timecards 845 for payment using the GUI. This can cause the server 830 to contact a financial processing system 870 to initiate payment for the various timecards. The financial processing system 870 can be any payment processor and can transfer funds to the respective workers electronically or through printed paper checks.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather, any feature of any example described here can be incorporated into any other suitable example. It is intended that the specification and examples be considered as exemplary only, with a true scope and spirit of the disclosure being indicated by the following claims.

1. A method for providing instant payroll with bulk approval, comprising:
receiving, at a server, a first timecard created by a user on a first user device through use of a graphical user interface (“GUI”), wherein the GUI receives selections to define an amount of time a first user worked;
receiving a manager approval at the server from the first user device, wherein the manager approval is entered on the same first user device used by the user to create the timecard as a perquisite to the first time card being sent to the server, and wherein the manager approval includes a manager credential entered on the first user device;
determining a reduced instant payment amount for the first timecard, wherein the reduced instant payment amount includes a first deduction for estimated tax and a second deduction based on a buffer, wherein the buffer corresponds to a worker type that applies to the first user, wherein different worker types correspond to different buffers;
sending, to an administrator device, a list of timecards for bulk approval by a super administrator, wherein the administrator device displays a GUI that allows for simultaneously approving payment for multiple timecards corresponding multiple users; and
sending the reduced instant payment amount to the first user device.

2. The method of claim 1, further comprising displaying, for timecard entry at the first user device, an industry-specific timecard template, wherein the server stores a profile that associates the user with the respective industry.

3. The method of claim 1, wherein the first deduction is an average deduction amount from a plurality of past paychecks indicated by the payroll history.

4. The method of claim 1, further comprising:
receiving an auto approval selection made by a manager of the user; and
automatically approving future timecards based on the amount of time falling within a threshold range,
wherein the list of timecards displays on the GUI of the administrator device for a super administrator, wherein each approved timecard includes an indication of approval status and number of hours worked.

5. The method of claim 1, wherein the GUI at the administrator device highlights a second timecard in the list of timecards for bulk approval based on the second timecard having a number of hours that falls outside of a threshold.

6. The method of claim 1, further comprising displaying, on the GUI of the first user device, the first deduction, the second deduction, a configurable fee that is withheld for an employer of the first user, and the reduced instant payment amount that is available based on the first and second deductions and other withholdings, wherein a contemporaneously displayed approval button allows the user to approve the reduced instant payment amount.

7. The method of claim 1, further comprising:
displaying, on the GUI of the administrator device, different maximum payment percentages or minimum deduction amounts with respect to W2 workers and 1099 workers, wherein the super administrator can change the maximums and minimums using the GUI.

8. A non-transitory, computer-readable medium comprising instructions that, when executed by a processor, cause the processor to perform stages for providing instant payroll with bulk approval, the stages comprising:
receiving, at a server, a first timecard created on a first user device through use of a graphical user interface (“GUI”), wherein the GUI receives selections to define an amount of time a first user worked;
receiving a manager approval at the server from the first user device, wherein the manager approval is entered on the same first user device used by the user to create the timecard as a perquisite to the first time card being sent to the server, and wherein the manager approval includes a manager credential entered on the first user device;
determining a reduced instant payment amount for the first timecard, wherein the reduced instant payment amount includes a first deduction for estimated tax and a second deduction based on a buffer, wherein the buffer corresponds to a worker type that applies to the first user, wherein different worker types correspond to different buffers;
sending, to an administrator device, a list of timecards for bulk approval by a super administrator, wherein the administrator device displays a GUI that allows for simultaneously approving payment for multiple timecards corresponding multiple users; and
sending the reduced instant payment amount to the first user device.

9. The non-transitory, computer-readable medium of claim 8, the stages further comprising displaying, for timecard entry at the first user device, an industry-specific timecard template, wherein the server stores a profile that associates the user with the respective industry.

10. The non-transitory, computer-readable medium of claim 8, wherein the first deduction is an average deduction amount from a plurality of past paychecks indicated by the payroll history.

11. The non-transitory, computer-readable medium of claim 8, further comprising:
receiving an auto approval selection made by a manager of the user; and
automatically approving future timecards based on the amount of time falling within a threshold range,
wherein the list of timecards displays on the GUI of the administrator device for a super administrator, wherein each approved timecard includes an indication of approval status and number of hours worked.

12. The non-transitory, computer-readable medium of claim 8, wherein the GUI at the administrator device highlights a second timecard in the list of timecards for bulk approval based on the second timecard having a number of hours that falls outside of a threshold.

13. The non-transitory, computer-readable medium of claim 8, the stages further comprising displaying, on the GUI of the first user device, the first deduction, the second deduction, a configurable fee that is withheld for an employer of the first user, and the reduced instant payment amount that is available based on the first and second deductions and other withholdings, wherein a contemporaneously displayed approval button allows the user to approve the reduced instant payment amount.

14. The non-transitory, computer-readable medium of claim 8, the stages further comprising:
displaying, on the GUI of the administrator device, different maximum payment percentages or minimum deduction amounts with respect to W2 workers and 1099 workers, wherein the super administrator can change the maximums and minimums using the GUI.

15. A system for providing instant payroll with bulk approval, the system comprising:
a non-transitory, computer-readable medium containing instructions; and
a processor that executes the monitoring module to perform stages comprising:
receiving, at a server, a first timecard created on a first user device through use of a graphical user interface (“GUI”), wherein the GUI receives selections to define an amount of time a first user worked;
receiving a manager approval at the server from the first user device, wherein the manager approval is entered on the same first user device used by the user to create the timecard as a perquisite to the first time card being sent to the server, and wherein the manager approval includes a manager credential entered on the first user device;
determining a reduced instant payment amount for the first timecard, wherein the reduced instant payment amount includes a first deduction for estimated tax and a second deduction based on a buffer, wherein the buffer corresponds to a worker type that applies to the first user, wherein different worker types correspond to different buffers;
sending, to an administrator device, a list of timecards for bulk approval by a super administrator, wherein the administrator device displays a GUI that allows for simultaneously approving payment for multiple timecards corresponding multiple users; and
sending the reduced instant payment amount to the first user device.

16. The system of claim 15, the stages further comprising displaying, for timecard entry at the first user device, an industry-specific timecard template, wherein the server stores a profile that associates the user with the respective industry.

17. The system of claim 15, wherein the first deduction is an average deduction amount from a plurality of past paychecks indicated by the payroll history.

18. The system of claim 15, further comprising:
receiving an auto approval selection made by a manager of the user; and
automatically approving future timecards based on the amount of time falling within a threshold range,
wherein the list of timecards displays on the GUI of the administrator device for a super administrator, wherein each approved timecard includes an indication of approval status and number of hours worked.

19. The system of claim 15, wherein the GUI at the administrator device highlights a second timecard in the list of timecards for bulk approval based on the second timecard having a number of hours that falls outside of a threshold.

20. The system of claim 15, the stages further comprising displaying, on the GUI of the first user device, the first deduction, the second deduction, a configurable fee that is withheld for an employer of the first user, and the reduced instant payment amount that is available based on the first and second deductions and other withholdings, wherein a contemporaneously displayed approval button allows the user to approve the reduced instant payment amount.
